(19) United States
(12) Patent Application Publication
(10) Pub. No.: US 2011/0062885 A1
(43) Pub. Date: Mar. 17, 2011

(54) METHOD OF DRIVING AN UHP GAS-DISCHARGE LAMP

(75) Inventors: Jens Pollmann-Retsch, Aachen (DE); Pavel Pekarski, Aachen (DE)

(73) Assignee: KONINKLIJKE PHILIPS ELECTRONICS N.V., EINDHOVEN (NL)

(21) Appl. No.: 12/991,954

(22) PCT Filed: May 7, 2009
(86) PCT No.: PCT/IB2009/051876

§ 371 Date: Nov. 10, 2010

(30) Foreign Application Priority Data
May 14, 2008 (EP) 08103939.8

(51) Int. Cl. H05B 41/36

(52) U.S. Cl. 315/291

(57) ABSTRACT

The invention describes a method of driving a gas-discharge lamp (1), wherein the lamp (1) is driven at any one time using one of a number of driving schemes, and wherein the lamp (1) is driven at a nominal operating power (Pₙₒₘ) or at a reduced operating power (P_{dim}). When the lamp is being driven at the nominal operating power (Pₙₒₘ), a driving scheme switch-over occurs according to a relationship between a first target voltage (V_{T1}) and the operating voltage of the lamp (1), and, when the lamp is being driven at the reduced operating power (P_{dim}), a driving scheme switch-over occurs according to a relationship between a second target voltage (V_{T2}) and the operating voltage of the lamp (1), which second target voltage (V_{T2}) is determined on the basis of the reduced operating power (P_{dim}). The invention further describes a driving unit (10) for driving a gas-discharge lamp (1) according to this method.

### FIELD OF THE INVENTION

The invention describes a method of driving a gas-discharge lamp, and a driving unit for driving a gas-discharge lamp.

### BACKGROUND OF THE INVENTION

In gas discharge lamps such as HID (High Intensity Discharge) and UHP (Ultra-High Pressure) lamps, a bright light is generated by a discharge arc spanning the gap between two electrodes disposed at opposite ends of a discharge chamber of the lamp. In short-arc and ultra-short-arc discharge lamps, the electrodes in the discharge chamber are separated by only a very short distance, for example one millimetre or less. The discharge arc that spans this gap during operation of the lamp is therefore also short, but of intense brightness. Such lamps are useful for applications requiring a bright, near point source of white light, for example in image projection applications or in automotive headlights.

When such a lamp is driven using alternating current (AC), each of the electrodes functions alternately as anode and cathode, so that the discharge arc alternately originates from one and then the other electrode. Ideally, the arc would always attach to the electrode at the same point, and would span the shortest possible distance between the two electrode tips. However, because of the high temperatures that are reached during AC operation at high voltages, the electrodes of a gas-discharge lamp are subject to physical changes, i.e. an electrode tip may melt or burn back, and structures may grow at one or more locations on the electrode tip at the point where the arc attaches to the tip. Such physical alterations to the electrode can adversely affect the brightness of the arc, since the arc may become longer or shorter, leading to fluctuations in the light output and collectable flux of the lamp. In the case of an automotive application such as a headlamp, it is important for obvious reasons that the light output is not subject to unpredictable variations. In an image projection system, an unstable light flux may be perceived as a flickering, an effect which is evidently undesirable.

Therefore, a stable arc length is of utmost importance in projection applications. Maintaining the light flux in modern projectors ultimately means maintaining a short arc-length for prolonged times. The arc length is directly related to the operating voltage of the lamp. This known relationship is used in some approaches to the problem, for example by switching between dedicated lamp driving schemes when the operating voltage reaches a predefined voltage target value. The lamp driving schemes serve to stabilise the arc length, and may include sophisticated combinations of different current wave shapes and operating frequencies, designed so that alterations to the electrode tips are avoided where possible, or that the growing and melting of structures on the electrodes occur in a controlled manner. Depending on the choice of lamp driving scheme, modifications to the electrode surface can take effect within short to very short time scales.

A state of the art driver for such a lamp is described in WO 2005/062684 A1 which is incorporated herein by reference and which describes a method in which a target voltage is predefined and the lamp driver uses the predefined value to decide when to switch between driving schemes or modes of operation with specific combinations of different current wave-shapes and operating frequencies, for instance whenever the observed operating voltage of the lamp crosses the target voltage value or deviates by a predefined amount from the target voltage value. In a first mode of operation, controlled growing of structures on the lamp's electrodes is achieved by means of a known rectangular wave shape of the lamp current upon which current-pulses are superimposed, directly preceding a commutation of the current. In a second mode of operation, a controlled melting back of the electrode front faces is achieved by driving the lamp at a higher frequency than in the first mode and without such a current-pulse superimposed on the current wave shape directly preceding the commutation of the current.

The predefined target voltage for a lamp series is determined for example during experiments carried out for a particular lamp type during the development stage. The target voltage can then be stored, for example in a memory of the lamp driver for use during operation of the lamp.

The light output of such a gas-discharge lamp can be reduced or dimmed, for example to render darker scenes in a movie using a projection system. This is done automatically during rendering of the movie. The light output of such a lamp can be dimmed for other reasons, for example to reduce the power consumption of the device, to reduce noise from cooling devices (fans), or to prolong the lifetime of the lamp by reducing the heat load on the lamp's components. Newer projection devices such as front projectors (‘beamers’) or rear-projection televisions with such a short-arc gas-discharge lamp sometimes offer the user a means of selecting a so-called “eco-mode” in which the lamp is operated at a lower power level than the nominal one.

However, at a reduced power level, the stabilisation technique based on the target voltage, as described above, is no longer effective. At a reduced power level, the arc length of the gas-discharge lamp varies considerably, leading to corresponding fluctuations in the operating voltage. This unsatisfactory behaviour may be perceptible to the user as flicker. Furthermore, the electrodes may deteriorate as a result of the fluctuations in voltage, particularly if the lamp is driven at the dimmed power level for prolonged periods of time. This deterioration can ultimately lead to failure of the lamp.

Therefore, it is an object of the invention to provide a method of driving a lamp of the type described at a reduced power level such that a stable light output can be maintained, while avoiding the problems mentioned above.

### SUMMARY OF THE INVENTION

To this end, the present invention describes a method of driving a gas-discharge lamp, wherein the lamp is driven at any one time using one of a number of driving schemes, and wherein the lamp can be driven at a nominal operating power or at a reduced operating power. When the lamp is being driven at the nominal operating power, a driving scheme switch-over occurs according to a relationship between a first target voltage and the operating voltage of the lamp. When the lamp is being driven at the reduced operating power, a driving scheme switch-over occurs according to a relationship between a second target voltage and the operating voltage of the lamp, which second target voltage is determined on the basis of the reduced operating power.

The mode of operation in which the lamp is driven at a nominal operating power level is usually referred to as ‘normal mode’, while the mode of operation at a reduced power level can be referred to as a ‘dimmed mode’ in the following. During any of the operation modes, the arc length of the lamp can be stabilised using a suitable technique, e.g. the technique described in WO 2005/062684 A1, but using the appropriate first or second target voltage, according to the operation mode in which the lamp is being driven.

An obvious advantage of the method according to the invention is that, in a dimmed mode of operation, the stabilisation schemes is specifically adapted to the reduced operating power, which can be determined in a relatively straightforward manner. This means that, using the method according to the invention, the arc-length of the lamp can be stabilized regardless of the operating mode in which the lamp is being driven.

An appropriate driving unit for driving a gas-discharge lamp comprises a power level input for providing a value of reduced operating power when the lamp is to be driven at a reduced operating power and a second target voltage determination unit for determining a second target voltage on the basis of the reduced operating power. The driving unit further comprises a voltage monitoring unit for monitoring the operating voltage of the lamp, and a driving scheme switching unit for initiating a driving scheme switch-over according to a relationship between a first target voltage and the operating voltage of the lamp when the lamp is being driven at a nominal operating power, or according to a relationship between the second target voltage and the operating voltage of the lamp when the lamp is being driven at the reduced operating power.

The dependent claims and the subsequent description disclose particularly advantageous embodiments and features of the invention.

The instant in time at which the lamp driver causes a driving scheme switch-over to take place is determined by the behaviour of the operating voltage with respect to a suitable parameter. In a particularly preferred embodiment of the invention, a driving scheme switch-over from one driving scheme to a subsequent driving scheme takes place when the operating voltage of the lamp increases to rise above a target voltage, or a driving scheme switch-over from a driving scheme to a subsequent driving scheme takes place when the operating voltage of the lamp decreases to drop below a target voltage. A target voltage can therefore be regarded as a kind of threshold level used to trigger a switch between driving schemes. Whenever the operating voltage crosses the target voltage, the lamp driver triggers a driving scheme switch-over. If the operating voltage drops below the target voltage, implying that the arc length is too short, a first driving scheme may be used in which the frequency of the lamp current can be sufficiently high so that the electrode tips melt back slightly. If the operating voltage increases above the target voltage, implying that the arc length is too long, a second driving scheme may be used in which the lamp current wave-shape includes a pulse that causes a tip to grow again on the front face of the electrode. By switching between driving schemes in this way, a stable discharge arc can be achieved.

In the method according to the invention, in a particular operation mode of the lamp, one driving scheme may be applied for operating voltages above a target voltage, and another driving scheme may be applied for operating voltages below that target voltage.

An operation mode of the lamp can be, for example, a nominal operation mode or a dimmed operation mode. In a dimmed mode of operation, the lamp can be driven so that it consumes less power. In these different operation modes, besides using distinct target voltages, different sets or combinations of driving schemes can be used in conjunction with the relevant target voltages so that an optimal arc-length stabilisation can be obtained for any operation mode of the lamp.

It has been observed that the arc length in a high-pressure lamp of the type described above is related to the operating voltage of the lamp. A higher voltage across the electrodes is associated with a melting of the electrode tips, so that the separation between the electrodes (which face each other from opposite ends of the glass envelope) and therefore also the arc-length, increases. Similarly, a lower voltage across the electrodes is associated with the growing of structures or tips on the electrode faces, so that the distance between the electrode tips is effectively decreased, and the arc length decreases accordingly.

In a preferred embodiment of the invention therefore, the second target voltage for use in the dimmed operation mode is determined such that the arc-length of the lamp is shorter when the lamp is being driven at the reduced operating power than when the lamp is being driven at the nominal operating power.

In the method according to the invention, instabilities arising from voltage variations during dimmed operation can essentially be eliminated, so that the arc-length and therefore also the collectable light-flux are stabilised. This is achieved by adapting the target voltage, i.e. determining a second target voltage, when the lamp power is dimmed. The second target voltage can be determined in different ways.

In one particularly straightforward embodiment of the invention, the second target voltage is determined by adapting the first target voltage on the basis of a ratio of the nominal operating power to the reduced operating power. For example, the first target voltage can be reduced by multiplying it with the fraction obtained by dividing the lower (dimmed) power level by the higher (nominal) power level, according to the following equation:

$${U}_{lo} = {U}_{hi} \cdot ( \frac{{P}_{lo}}{{P}_{hi}} ) \qquad ( 1 )$$

where Uₗₒ is the second target voltage for the dimmed mode of operation, Uₕᵢ is the nominal operating voltage, Pₗₒ is the chosen power level at which the lamp is to be driven, and Pₕ, is the nominal lamp power value, or rated power of the lamp. Here, the subscripts ‘hi’ and ‘lo’ indicate the high (nominal) and low (dimmed) modes of operation, respectively. The second target voltage is obtained by simply reducing the first target voltage by the same percentage as the operating power is reduced.

Such a strategy will keep the average lamp-current constant at all power levels, thus maintaining a steady current flow between the electrodes. In a further preferred embodiment of the invention, the second target voltage can be determined on the basis of a relationship between the reduced operating power and a nominal current of the lamp. Since power equals voltage times current, and the nominal operating voltage Uₕᵢ and nominal power Pₕᵢ are known values, equation (1) reduces to

$${U}_{lo} = \frac{{P}_{lo}}{{I}_{hi}} \qquad ( 2 )$$

so that the second target voltage Uₗₒ for use in the dimmed mode of operation can be determined using the chosen dimmed power level Pₗₒ and a known or measured nominal lamp current value Iₕᵢ. For example, a driving unit may preferably comprise a current monitoring unit as well as a voltage monitoring unit, so that the lamp current can be measured during operation in a normal mode. This value of lamp current Iₕᵢ can then be used to obtain the second target voltage value when the lamp power is reduced to the lower level Pₗₒ.

As mentioned in the introduction, a switch-over between different driving schemes serves to stabilise the arc-length of the lamp. The stabilisation of the arc-length when using these advanced lamp-driving schemes is a consequence of the well-controlled behaviour of the electrodes. One of the most important influencing parameters for the electrode behaviour is the current flowing through the electrodes. Equations (1) and (2) show that, at the lower or dimmed power level, the electrode current has essentially the same value as when the lamp is driven at nominal power. By keeping the current essentially constant, the load on the electrodes can also be maintained at a more or less constant level, so that, at lower power levels, the electrodes behave in the same way as at nominal power level, i.e. structures or tips grow and melt on the electrodes in a controlled manner over similar spatial and temporal scales.

Experiments have shown that the electrical and optical efficiency of a gas-discharge lamp of the type described above is influenced by the arc-length and therefore, indirectly, by the operating voltage. Measurements can be made for a certain lamp type to determine the values of operating voltage and operating power at which this lamp type attains a maximum in electro-optical efficiency. Generally, an electro-optical efficiency curve shows a clear range of values for operating voltage and power within which the electro-optical efficiency of the lamp is acceptable. Outside of this range, the light output and flux of the lamp would be unacceptably low. However, a value of second target voltage determined using equations (1) or (2) above might be so low that, using this second target voltage, the lamp would be driven such that its electro-optical efficiency is unacceptably poor. Therefore, in a further preferred embodiment of the invention, the second target voltage is determined according to an upper and/or lower threshold level. On the basis of experimental values for a lamp type, for example, a restricted range of values for the operating voltage can be determined such that an acceptable electro-optical efficiency is maintained, even in a dimmed mode of operation, while ensuring that the operating voltage is neither too high nor too low, regardless of operating mode. Threshold values bounding this voltage range can be stored in a non-volatile memory of the lamp driver. For example, for a lamp with nominal power of 125 W with a nominal current of 2 A, experimental values may show that the operating voltage should not drop below 50V nor exceed 70V if a certain minimum of electro-optical efficiency is to be maintained. Therefore, for this lamp, a lower threshold value of 50V and an upper threshold value of 70V would be defined. If the second target voltage value determined using equations (1) or (2) is lower than the lower threshold level, the lower threshold level would be used instead. In this way, it can be ensured in a straightforward manner that the lamp always delivers at least a minimum of electro-optical efficiency.

Alternatively, instead of using the linear approach of equations (1) and (2), in which a reduction in lamp power results in a possibly too severe reduction in lamp voltage, a non-linear approach can be used instead which avoids an excessive reduction in target voltage in a dimmed mode of operation. In a preferred embodiment of the invention, therefore, the second target voltage can be obtained using a non-linear version of equation (1) as follows:

$${U}_{lo} = {U}_{hi} \cdot {( \frac{{P}_{lo}}{{P}_{hi}} )}^{α} \qquad ( 3 )$$

where Uₗₒ corresponds to the second target voltage, Uₕᵢ corresponds to the first target voltage, Pₕᵢ corresponds to the nominal operating power, and Pₗₒ corresponds to the reduced operating power, and the scalar exponent α is a positive real number greater than 0 and less than or equal to 1. With α=1, equation (3) simplifies to equation (1). Again, measurements obtained experimentally for a certain lamp type can be made to determine one or more suitable values of the scalar exponent α. For instance, the choice of which exponent value to use may be governed by the size of the ratio of lower lamp power to nominal lamp power, i.e. the degree of dimming may influence the choice of exponent value. These values can be stored in a non-volatile memory for use by the lamp driver.

Evidently, in the method according to the invention, a voltage value obtained using equation (3) could also be subject to upper and lower threshold levels or limits, as described above, for example to ensure that a second target voltage determined using equation (3) is never less than a minimum required value.

A sudden change in power and voltage can result in unstable behaviour of the lamp for a period of time until the environment in the lamp has settled. To avoid such instabilities when changing between operating modes, in a further embodiment of the invention, a change in lamp power from a first operating power to a second operating power can be effected over a time interval in a graduated manner, such that the lamp power is adjusted step-wise towards the second operating power level. During this time interval, intermediate voltage target values can be determined, for example using one of the techniques described above. For example, when changing from the nominal power level to a reduced power level, step-wise lower values of lamp power can be used to determine a series of target voltage values until the desired power level and therefore the ultimate second target voltage level are reached.

The decision to change between nominal and reduced operating power levels can be made automatically, for example by a suitable software algorithm running on a processor of the lamp driver. This may be done to automatically operate the lamp such that the lamp life-span is optimized. In an alternative embodiment of the invention, the operating power of the lamp can be specified by a user input, for example the user may use a remote control for the projector or beamer to cause the lamp driver in the projector to drive the lamp at the nominal power or at a reduced power. The remote control may have a dedicated button for this purpose, or the user can use different buttons on the remote control to navigate through a dialogue shown, for example, on a TV screen, in order to choose the appropriate option. The voltage target value can then be determined according to the operation mode in which the lamp is to be driven.

Since this voltage target value will be required by the lamp driver for an indeterminate length of time, the determined target voltage value is preferably stored in a non-volatile memory which can be accessed by the lamp driver. This means that the lamp driver needs only to calculate this value once and can thereafter simply refer to the stored value of the target voltage when the momentary operating voltage of the lamp has to be compared to the target voltage. A non-volatile memory is also of particular advantage when the lamp is to be re-started in the same operation mode after a lamp-switch-off.

Evidently, the method and driving unit according to the invention could be applied to any application that makes use of a short-arc gas-discharge lamp as described, requiring a stable arc and constant light flux. Any existing state of the art driving unit for a short-arc gas-discharge lamp could conceivably be modified to allow the lamp to be driven using the method according to the invention. For example, with relatively little effort, software modules and/or hardware components could be replaced in or added to an existing projection system driving unit.

Other objects and features of the present invention will become apparent from the following detailed descriptions considered in conjunction with the accompanying drawings. It is to be understood, however, that the drawings are designed solely for the purposes of illustration and not as a definition of the limits of the invention.

### BRIEF DESCRIPTION OF THE DRAWINGS

FIG. 1a shows simplified graphs of operating power, voltage and current for a lamp driven according to a prior art method.

FIG. 1b shows a simplified graph of operating voltage for a lamp driven according to a prior art method.

FIG. 2 shows a graph of electro-optical efficiency for an ultra-short-arc UHP lamp with a nominal power of 125 W.

FIG. 3 shows graphs of operating voltage against power ratio for the lamp of FIG. 2.

FIG. 4 shows a gas-discharge lamp and a block diagram of a possible realisation of a driving unit according to the invention.

FIG. 5a shows simplified graphs of operating power, voltage and current for a lamp driven using the method according to the invention.

FIG. 5b shows a simplified graph of operating voltage for a lamp driven using the method according to the invention.

In the drawings, like numbers refer to like objects throughout. Objects in the diagrams are not necessarily drawn to scale.

### DETAILED DESCRIPTION OF THE EMBODIMENTS

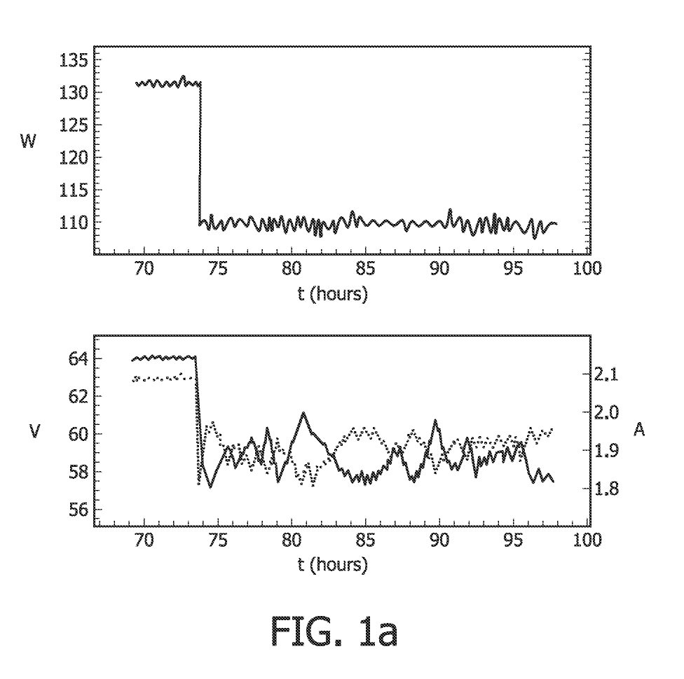

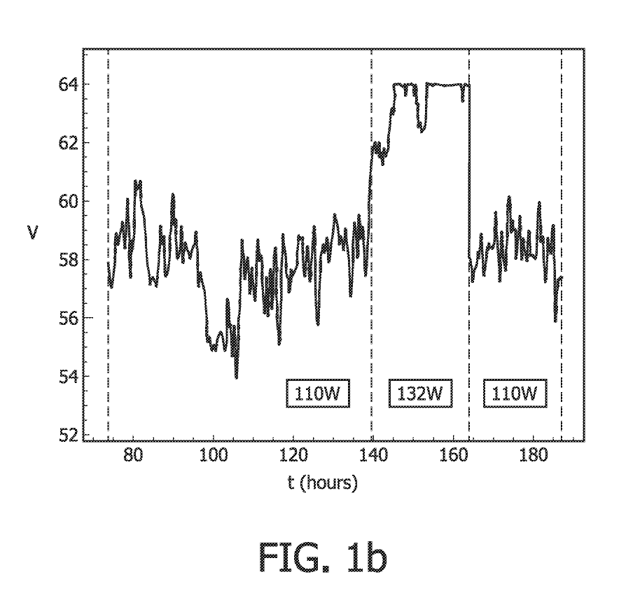

FIG. 1a shows simplified graphs of operating power (upper graph), voltage and current (lower graph), over a short time span of approximately thirty hours for a 132W ultra short-arc UHP lamp for a lamp driven according to a prior art method, such as that described in WO 2005/062684 A1, in which a predetermined target voltage is used by the driver of the lamp to determine when to switch between driving schemes. For the sake of clarity, this graph and the following graphs show smoothed lines in place of actual measured values.

The upper graph in FIG. 1a shows that, at about 74 hours of operation, the lamp power is reduced from the nominal value of 132 W to 110 W, and the lamp power is maintained at this reduced level for the remainder. The behaviour of the lamp voltage (solid line) and current (dotted line) is shown in the lower graph. Prior to reducing the lamp power, the lamp voltage and current show essentially stable levels at about 64V and 2.1 A respectively. However, after the lamp power is reduced, the lamp voltage and lamp current behave in an erratic manner. The result of these instabilities is a fluctuation in light output of the lamp.

The prior art method of driving the lamp works well as long as the operating voltage actually reaches or crosses the target voltage, thus triggering the driving scheme switch-overs, as can be seen by the relatively constant levels of voltage and current during lamp operation at nominal power level. However, once the operating voltage drops as a result of a drop in lamp power, the fixed value of voltage target is no longer useful as a criterion since the lamp voltage is no longer in this range, and, as a result, the lamp driver cannot trigger the desired changeovers between driving schemes. During lamp operation at lower power, therefore, the lamp voltage and current exhibit unpredictable and undesirable levels of fluctuation. This is shown more clearly in FIG. 1b, which shows lamp voltage over a long period of time, in this case more than one hundred hours. The lamp is driven at nominal or reduced power levels, as indicated by the values of power in the different regions of the graph. During periods of operation at nominal power, the lamp voltage can stabilise and eventually settles to a relatively constant value. However, during operation at reduced power levels, the lamp voltage fluctuates unpredictably.

This undesirable situation is remedied by the method according to the invention, which may utilise a driving scheme management method based on WO 2005/062684 A1 described above, or a similar driving scheme, but determines a second voltage target level for the lamp when driven at a reduced power level, for example using equation (1) or (2) and using values of operating voltage and current measured in the lamp driver using appropriate circuit elements, as will be explained in detail below.

Lamps of the type described above are generally driven at their nominal power level, i.e. at a predetermined operating voltage level, so that a desired light output is obtained. If a lamp is driven at a voltage level that is too high or too low, the light output of the lamp, and therefore the collectable flux, will not be satisfactory. For any lamp type, experimental measurements can be observed and the results plotted to obtain a graph of electro-optical efficiency. Alternatively, a theoretical model could be used (cf. “Light-sources for small-etendue applications: A comparison of Xenon- and UHP-lamps”,

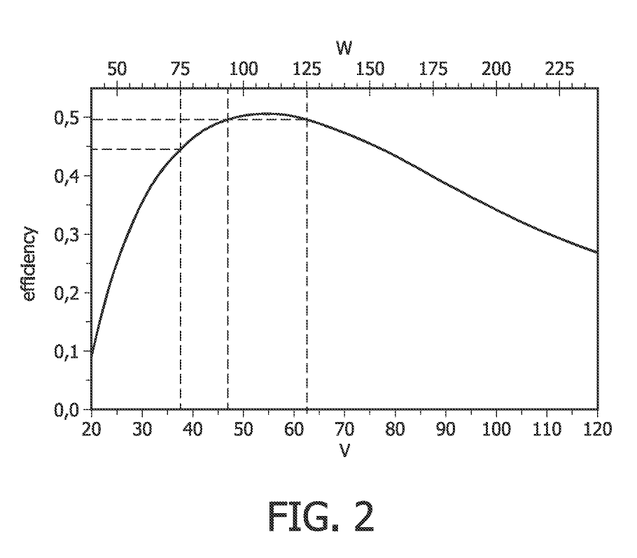

Proceedings of SPIE Vol. 5740, p. 13-26, 2005) that allows calculation of the electro-optical efficiency with high accuracy when the properties of lamp and application are known. Such a graph is shown in FIG. 2, calculated for an ultra-short-arc UHP lamp with a nominal power of 125 W, a nominal current of 2 A, and a lamp pressure of 250 bar. The resulting graph shows a clear maximum for the electro-optical efficiency for this lamp near the 125 W mark (upper dashed line). When the lamp is dimmed to 60% of its nominal power, i.e. to 75 W, the second target voltage would have to be decreased from an original target voltage of 62.5V to 37.5V. As can be read from the graph, driving the lamp at this lower voltage level would yield an unacceptably low level of efficiency (lower dashed line). Not only would the lamp noticeably yield less light output as a result of the drop in power; a loss in light flux in the application of approximately 10% would also arise due to the lower electro-optical efficiency. To avoid a too severe drop in lamp power, the second target determined using a method according to the invention can be restricted to lie within a certain range, as explained above. For example, the range can be bounded by the upper dashed line, i.e. between 47V and 62.5V. In this example, if the lamp is to be dimmed, the second operating voltage—37.5V—determined using the simple formula of equation (1) will lie outside of the range given by the upper dashed line. In this case, the lower threshold limit, i.e. 47V, is used as the second target voltage.

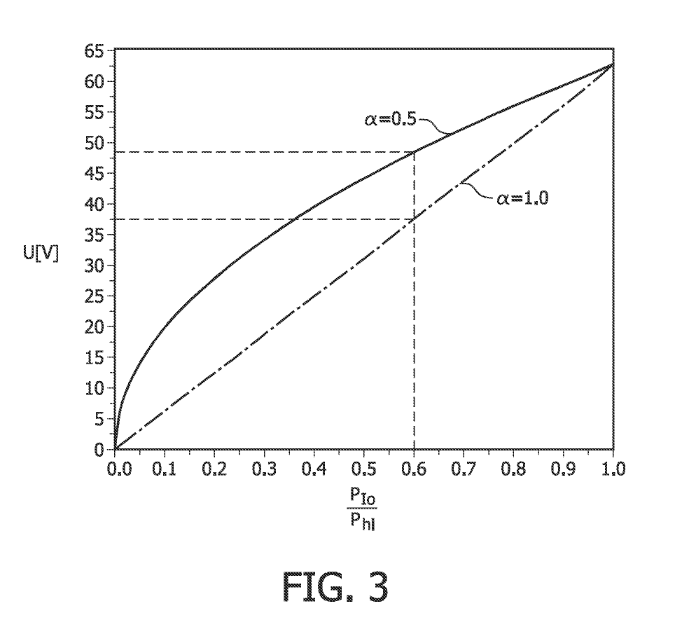

FIG. 3 illustrates another approach to obtaining a better second target voltage value than that obtained using the linear approach of equations (1) and (2). Here, graphs of the second target voltage against the power ratio for the lamp of FIG. 2 are shown. The straight dashed line shows the value of the second target voltage Uₗₒ against the ratio Pₗₒ/Pₕᵢ, calculated according to equation (1). At the lamp's nominal power (Pₗₒ/Pₕᵢ=1), the lamp voltage would be its nominal voltage, i.e. 62.5V. When the lamp is driven at 60% of its nominal power, equation (1) would yield a value of 37.5V for the second target voltage Uₗₒ, which would result in an unsatisfactory performance as explained above. A better result is obtained using equation (3). Results using α=0.5 are plotted with the solid line. At 60% of nominal power, this curve gives a second target voltage Uₗₒ of 48.4V, which lies within the acceptable range shown in FIG. 2. This non-linear approach evidently yields better results, i.e. higher second target voltage values, than the linear approach.

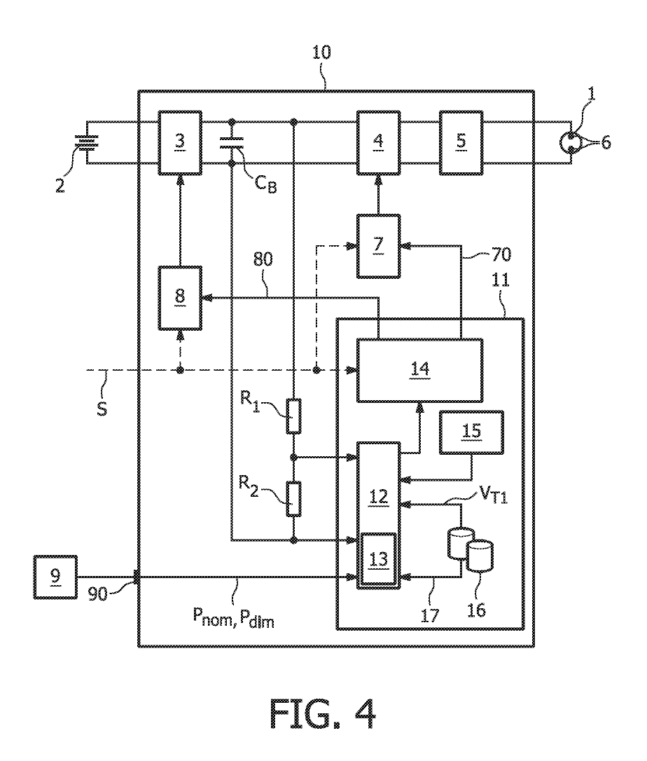

FIG. 4 shows a gas discharge lamp 1 and a block diagram of one embodiment of a driving unit 10 according to the invention. The system as shown can be used, for example, as part of a projection system.

The circuit shown comprises a power source 2 with a DC supply voltage, for example, 380V for a down converter unit 3. The output of the down converter unit 3 is connected via a buffer capacitor C_{B} to a commutation unit 4, which in turn supplies an ignition stage 5 by means of which the lamp 1 is ignited and operated. When the lamp 1 is ignited, a discharge arc is established between the electrodes 6 of the lamp 1. The frequency of the lamp current is controlled by a frequency generator 7, and the wave shape of the lamp current is controlled by a wave forming unit 8. A control unit 11 whose function will be explained in more detail, supplies control signals 70, 80 to the frequency generator 7 and wave forming unit 8 respectively so that the amplitude, frequency and wave-shape of the lamp voltage and current can be controlled according to the momentary requirements.

The voltage applied to the buffer capacitor C_{B} is additionally fed via a voltage divider R₁, R₂ to a voltage monitoring unit 12 in the control unit 11. The voltage monitoring unit 12 monitors the operating voltage of the lamp 1. The operating voltage can be measured at predetermined time intervals given by a timer 15 or clock 15.

A power level selector 9, shown external to the driving unit 10, is used to set a level of power at which the lamp 1 is to be driven. The power level selector 9 can comprise a button on a remote control unit, for example. The chosen power level Pₙₒₘ, P_{dim} is forwarded by means of a suitable power level input 90 to the control unit 11. When the power level Pₙₒₘ indicates that the lamp 1 is to be driven at its nominal power, a first voltage target level V_{T1}, retrieved from a non-volatile memory 16, is used to control the lamp stabilization management by causing switch-overs between driving schemes according to whether the lamp voltage rises above the first target voltage V_{T1}, or drops below the first target voltage V_{T1}, as described in WO 2005/062684 A1. When the power level signal P_{dim} indicates that the lamp 1 is being driven at a reduced power level, a target voltage determination unit 13, on the basis of parameter values 17 stored in the memory 16, calculates a second target voltage V_{T2}. The parameters 17 required by the target voltage determination unit 13 will depend on the approach taken. For example, if equation (1) is used to calculate the second target voltage V_{T2}, the target voltage determination unit 13 will require values for nominal power Pₕᵢ and nominal operating voltage Uₕᵢ. If equation (3) is to be used, the target voltage determination unit 13 will additionally require a value for α. Alternatively, a type of look-up table that has been obtained at manufacturing time using one of the approaches above could be used to determine the second target voltage V_{T2}.

Instead of retrieving a pre-defined value of first target voltage V_{T1} as described above, the target voltage determination unit 13 could, of course, also be used to calculate this value. In this way, for any operation mode of the lamp 1, the momentary target voltage value can be determined in a dynamic manner.

On the basis of a control output from the voltage monitoring unit 12, a driving scheme switching unit 14 decides on the wave shape and frequency with which the lamp 1 is to be driven at any one time, and supplies the appropriate signals 70, 80 to the frequency generator 7, which drives the commutation unit 4 at the appropriate frequency, and to the wave-shaping unit 8, which, using the down converter 3, ensures that the correct current/pulse wave shape is generated for the desired driving scheme or operation mode. Possible driving scheme parameters (wave-shape, frequency etc.) are described in WO 2005/062684 A1.

When the driving unit 10 shown is used in a projection system, a synchronisation signal S can be supplied from an external source (not shown) to the driving unit 10, and is distributed to the frequency generator 7, the wave-shaping unit 8 and the control unit 11, so that the lamp driver 10 can operate synchronously with, for example, a display unit or a colour generation unit of the projection system.

In the diagram, the memory 16, the driving scheme switching unit 14, the voltage monitoring unit 12, the second target voltage determination unit 13, and the timer 15 are all shown as part of the control unit 11. Evidently, this is only an exemplary illustration, and these units could be realised separately if required. The control unit 11 or at least parts of the control unit 11, such as the driving scheme switching unit 14 or second target voltage determination unit 13, can be realised as appropriate software that can run on a processor of the driving unit 10. This advantageously allows an existing lamp driving unit to be upgraded to operate using the method according to the invention, provided that the driving unit is equipped with the necessary wave-shaping unit and frequency generator. The driving unit 10 is preferably also equipped with a suitable interface (not shown in the diagram) so that the first target voltage and other parameters required for the calculation of the second target voltage can be loaded into the memory 16 at time of manufacture or at a later time, for example when a different lamp type is substituted or a different performance is desired.

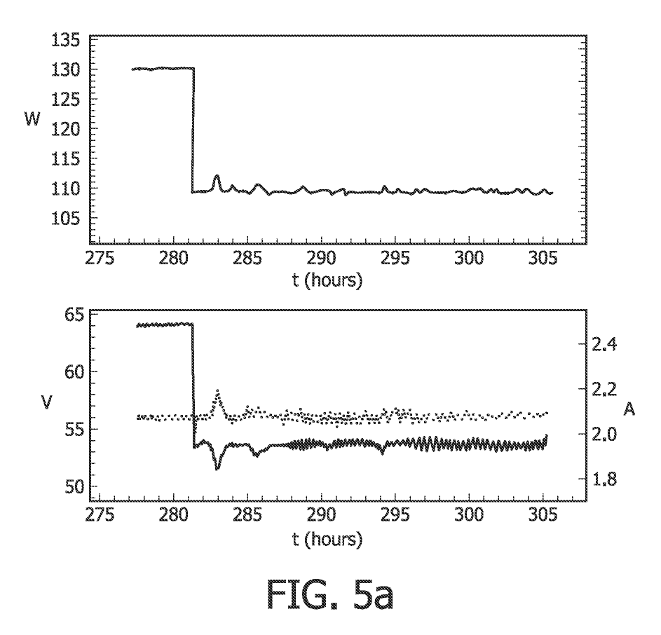

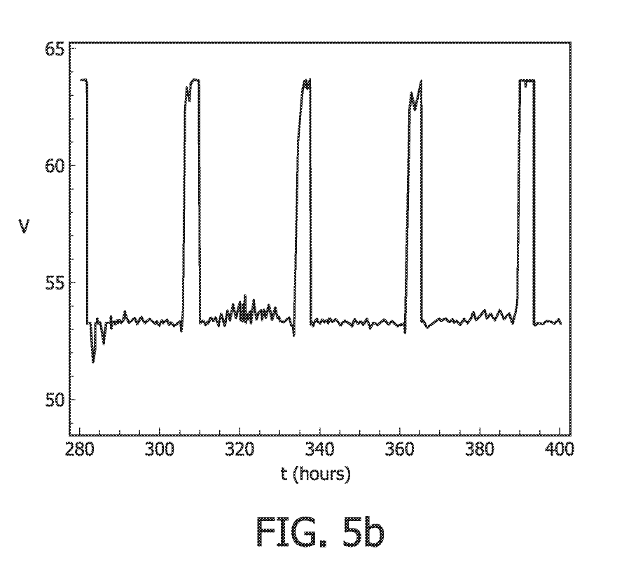

FIG. 5a shows graphs of operating power, voltage and current for the same lamp as in FIGS. 1a and 1b, but driven using the method according to the invention and using a lamp driver of the type described above, in which a second voltage target is calculated during the phases during which the lamp is driven at a level of power less than the nominal power. The upper graph in FIG. 5a shows lamp power, showing measurements taken over about 25 hours of operation. In the lower graph, it can clearly be seen that, after a short settling time, the lamp voltage (solid line) and lamp current (dotted line) only fluctuate by acceptable small amounts about levels of 53V and 2.05 A respectively. In particular, the lamp current does not change significantly between the nominal and the dimmed operation modes. The benefit of the method according to the invention can be even more clearly seen in FIG. 5b, which shows the behaviour of lamp voltage over a longer time span, in this case over 120 hours of operation. For the measurements of FIG. 5b, the lamp power was intermittently increased to the nominal level of 132 W (corresponding to the regions with peak voltage values in the graph) and then reduced again to 110 W (corresponding to the regions with lower voltage values). The graph clearly shows that the lamp voltage settled to relatively constant (albeit different) levels during both power level phases (compared to the situation of FIG. 1b).

The invention can preferably be used with all types of ultra-short-arc UHP lamps that can be driven with the method described above in applications requiring a stable arc (both axial and lateral). Although the present invention has been disclosed in the form of preferred embodiments and variations thereon, it will be understood that numerous additional modifications and variations could be made thereto without departing from the scope of the invention. It is also conceivable that a lamp driver could manage several different target voltages for a lamp, and can apply a particular target voltage according to the conditions under which the lamp is being driven at any one time. Each of these target voltages can be determined using any of the methods described above.

For the sake of clarity, it is to be understood that the use of “a” or “an” throughout this application does not exclude a plurality, and “comprising” does not exclude other steps or elements. A “unit” or “module” can comprise a number of units or modules, unless otherwise stated.

1. A method of driving a gas-discharge lamp (1),
wherein the lamp (1) is driven at any one time using one of a number of driving schemes;
and wherein the lamp (1) is driven at a nominal operating power (Pₙₒₘ) or at a reduced operating power (P_{dim});
and wherein, when the lamp is being driven at the nominal operating power (Pₙₒₘ), a driving scheme switch-over occurs according to a relationship between a first target voltage (V_{T1}) and the operating voltage of the lamp (1);
and wherein, when the lamp is being driven at the reduced operating power (P_{dim}), a driving scheme switch-over occurs according to a relationship between a second target voltage (V_{T2}) and the operating voltage of the lamp (1), which second target voltage (V_{T2}) is determined on the basis of the reduced operating power (P_{dim}).

2. A method according to claim 1, wherein a switch-over between different driving schemes serves to stabilise an arc-length of the lamp (1), and wherein the second target voltage (V_{T2}) is determined such that the arc-length of the lamp (1) is shorter when the lamp (1) is being driven at the reduced operating power (P_{dim}) than when the lamp (1) is being driven at the nominal operating power (Pₙₒₘ).

3. A method according to claim 1, wherein the second target voltage (V_{T2}) is determined by adapting the first target voltage (V_{T1}) on the basis of a ratio of the nominal operating power (Pₙₒₘ) to the reduced operating power (P_{dim}).

4. A method according to claim 3, wherein the second target voltage (V_{T2}) is obtained using the formula
$${U}_{lo} = {U}_{hi} \cdot {( \frac{{P}_{lo}}{{P}_{hi}} )}^{α}$$
where Uₗₒ is the value of the second target voltage (V_{T2}), Uₕᵢ is the value of the first target voltage (V_{T1}), Pₕᵢ is the value of the nominal operating power (Pₙₒₘ), Pₗₒ is the value of the reduced operating power (P_{dim}), and α is a positive real number such that 0≦α≦1.

5. A method according to claim 1, wherein the second target voltage (V_{T2}) is determined on the basis of a relationship between the reduced operating power (P_{dim}) and a nominal current of the lamp (1).

6. A method according to claim 1, wherein the second target voltage (V_{T2}) is determined according to an upper and/or lower threshold level.

7. A method according to claim 1, wherein a driving scheme switch-over from a first driving scheme to a second driving scheme takes place when the operating voltage of the lamp (1) increases above a target voltage (V_{T1}, V_{T2}), and a driving scheme switch-over from a second driving scheme to a first driving scheme takes place when the operating voltage of the lamp (1) drops below a target voltage (V_{T1}, V_{T2}).

8. A method according to claim 1, wherein a change in lamp power from a nominal operating power (Pₙₒₘ) to a reduced operating power (P_{dim}) is effected over a time interval in a graduated manner, such that the lamp power is reduced step-wise towards the level of reduced operating power (P_{dim}), and intermediate voltage target values are determined during this time interval.

9. A method according to claim 1, wherein, when the lamp power is increased from a reduced operating power (P_{dim}) to a nominal operating power (Pₙₒₘ), a first target voltage (V_{T1}) is determined on the basis of the lamp current.

10. A method according to claim 1, wherein the operating power (Pₙₒₘ, P_{dim}) of the lamp is specified by a user input.

11. A driving unit (10) for driving a gas-discharge lamp (1) comprising
a power level input (90) for providing a value of reduced operating power (P_{dim}) when the lamp is to be driven at a reduced operating power (P_{dim});
a target voltage determination unit (13) for determining a second target voltage (V_{T2}) on the basis of the reduced operating power (P_{dim});
a voltage monitoring unit (12) for monitoring the operating voltage of the lamp (1);
a driving scheme switching unit (14) for initiating a driving scheme switch-over according to a relationship between a first target voltage (V_{T1}) and the operating voltage of the lamp (1) when the lamp is being driven at a nominal operating power (Pₙₒₘ), or according to a relationship between the second target voltage (V_{T2}) and the operating voltage of the lamp (1) when the lamp is being driven at the reduced operating power (P_{dim}).

12. A projection system comprising a gas-discharge lamp (1) and a driving unit (10) according to claim 11.
